(19) United States
(12) Patent Application Publication
(10) Pub. No.: US 2025/0233290 A1
(43) Pub. Date: Jul. 17, 2025

(54) Battery with plastic housing and manufacturing process

(71) Applicant: Wyon AG, Appenzell Steinegg (CH)

(72) Inventor: Uwe Bernholz, Brülisau (CH)

(73) Assignee: Wyon AG, Appenzell Steinegg (CH)

(21) Appl. No.: 18/719,123

(22) PCT Filed: Nov. 30, 2022
(86) PCT No.: PCT/EP2022/083922

§ 371 Date: Jun. 12, 2024

(30) Foreign Application Priority Data
Dec. 20, 2021 (EP) EP21215980.0

(51) Int. Cl. H01M 50/567; H01M 50/121; H01M 50/172; H01M 50/533; H01M 50/54; H01M 50/552

(52) U.S. Cl. CPC H01M 50/567; H01M 50/121; H01M 50/172; H01M 50/533; H01M 50/54; H01M 50/552

(57) ABSTRACT

The present application relates to a battery. According to the invention, the battery comprises a housing made of plastic, which has a cavity delimited by an inner wall of the housing, in which a stack of electrodes is arranged and an electrolyte solution is filled. At least one feed-through element protrudes from a surface of the housing through the housing at least partially into the cavity. At least one contact element made of a conductive material is arranged inside the cavity and is conductively connected to the at least one feed-through element. The at least one contact element is arranged in the cavity in such a way that tab elements of like-poled electrodes of the electrode stack are held in a clamping manner between at least a first surface of the at least one contact element and the inner wall.

### TECHNICAL AREA

The invention relates to a battery, in particular a lithium-ion battery, with a housing made of plastic and at least one feed-through element which projects from a surface of the housing at least partially into a cavity of the housing. Furthermore, the present invention relates to a method of manufacturing such a battery.

### STATE OF THE ART

A battery is an electrochemical energy storage device and an energy converter. During discharge, stored chemical energy is converted into electrical energy. This electrical energy can be used by an electrical device which is independent of the power grid. The electrical energy supply of medical devices that are partially or fully implanted, such as pacemakers, hearing aids, insulin pumps and medication dispensers, poses a particular challenge in terms of the size, safety and performance of a battery. There is also an increasing demand for smaller batteries with undiminished performance and runtime for everyday entertainment devices.

Primary batteries can only be discharged once and cannot be recharged. Although the electrochemical reactions in these batteries can be partially reversed, they no longer lead to the restoration of an energy content similar to the initial state.

Secondary batteries, also known as accumulators, can be restored to an energy content largely corresponding to an initial state after discharge, so that a repeated conversion of chemical energy into electrical energy and vice-versa is possible. Different types of secondary batteries are known. Lithium-ion batteries are preferred for many applications due to their high energy density.

With both types of batteries, there is a problem in conducting the electrical energy generated by the electrochemical conversion reactions out of the battery and, in the case of secondary batteries, back into the battery, especially if the battery has a housing made of a plastic that is non-conductive or only very weakly conductive.

In particular secondary batteries usually comprise an electrode stack in which a number of anode and cathode electrodes are arranged. Electrical current has to be conveyed away of each of these electrode electrodes, which is usually done by means of so-called tab elements made of a conductive material. These tab elements have to be bundled, respectively their current has to be collected and then conveyed out of the battery, in particular via feed-through elements. In secondary batteries, current is supplied to the respective electrodes via the feed-through elements and the tab elements to charge the secondary battery. A regularly arising problem thereby is how the tab elements can be brought together or bundled, and connected to feed-through elements in a compact, short-circuit-proof and damage-proof way.

DE 29 06 853 (SAFT-Societe des Accumulateurs Fixes et de Traction SA) discloses an accumulator with two sets of electrode plates, each of which is electrically connected to one of the two poles. The poles pass through the accumulator cover and are provided with electrical connections on an outer part, while the electrodes are connected to the pole part inside the accumulator via metal strips. The superimposed metal strips are attached to the cell terminal by welding, riveting or screwing. In one embodiment, the metal strips are pressed against the cell terminal by means of a screw with a washer in between.

US 2010/01233527 A1 (International Battery Inc.) describes battery connections, in particular for lithium-ion batteries. The tab elements of the cathodes and anodes are each combined into two groups. The tab elements are connected to a respective feedthrough block by means of a rivet or a screw. The feed-through block has a base body from which a feed-through pin protrudes and a through-hole. The tab elements are collected and placed on top of each other before a hole is made in them for the rivet or screw. The tab elements can also be collected in a sleeve in order to better press them together. The tab elements are clamped onto the feed-through block via the rivet or screw.

WO 95/16282 (Valence Technology Inc.) relates to devices for fastening tab elements of batteries. Each tab element has a hole through which a fastening element can be passed. The fastener can be a rivet or a bolt. A first half of the tab elements of the anodes are arranged between a first press plate and the terminal, while a second half of the tab elements are arranged between the terminal and a second press plate. The press plates are pressed together and onto the pole by inserting a bolt from the first press plate into a nut on the second press plate and tightening it.

US 2005/0210660 A1 (Wenman Li) discloses methods for attaching tab elements of batteries. In a first step, the tab elements of the anodes and cathodes are stacked on top of each other. The tab elements are aligned with each other and then a hole is punched through the tab stacks. The tab stacks are inserted into pole blocks and connected to them by means of at least one rivet.

### SUMMARY OF THE INVENTION

The problem to be solved by the invention is to create a battery belonging to the technical field mentioned at the onset, which includes a connection between tab elements and a feed-through element that is as simple, space-saving and reliable as possible.

The solution to the problem is defined by the features of claim 1. According to the invention, a battery comprises a housing made of plastic, which has a cavity delimited by an inner wall of the housing, in which a stack of electrodes is arranged. At least one feed-through element extends from a surface of the housing through the housing at least partially into the cavity. A contact element made of a conductive material is arranged inside the cavity and is connected to the feed-through element. The tab elements of electrodes of the same polarity of the electrode stack are arranged between at least one first surface of the at least one contact element and the inner wall. The feed-through element interacts with the housing in such a way that the at least one contact element exerts a clamping force on the tab elements arranged between the at least one first surface and the inner wall.

By clamping the tab elements between the at least one first surface of the at least one contact element and the inner wall, the tab elements can be collected and fixed in a simple and space-saving manner. In addition, the transfer of current from the tab elements to the feed-through element can be realized with a small number of components. This simplifies the production of the battery and leads to lower manufacturing costs.

The battery according to the invention is preferably a secondary battery, in particular preferably a lithium-ion battery.

Plastic housings can be manufactured easily, cost-effectively and with customer-specific dimensions, for example by injection molding. A plastic housing is preferably electrolyte-resistant, corrosion-resistant and/or electrically insulating. With an electrically insulating housing, there is no need to maintain a safety distance between the inner wall of the housing and the electrode stack, i.e. the electrode stack can touch the inner wall of the housing, so that a larger surface area is available for the electrode stack with the same dimensions of the housing or cavity compared with a battery with an electrically conductive housing. Additional energy content can also be gained by fitting the battery precisely into a device, which is particularly easy with a plastic housing. With a plastic housing, the design is hardly restricted.

Advantageously, the plastic LCP (liquid-crystal polymer) or polyethylene (PE) is used for the housing. Preferably, the housing consists of or contains carbon fiber-reinforced LCP.

The plastic housing preferably has a wall thickness of less than 0.5 mm, in particular of less than 0.3 mm, and in particular of 0.2 mm or less. The wall thickness plays an important role in small batteries, as a reduction in the wall thickness can be used to insert a larger stack of electrodes into the housing and thus increase the capacity of the battery in a small battery with predefined dimensions.

The housing is preferably gas-tight, electrolyte-resistant, corrosion-resistant and/or electrically insulating. Gas-tight housings enable a long service life of the battery as outgassing is not possible and no undesirable substances can diffuse into the cavity of the housing.

Preferably, the housing consists of two parts that are joined together in a gas-tight manner during manufacture, e.g. by welding. In particular, the housing can consist of a housing cup and a housing cover.

Preferably, the battery according to the invention is a small battery or a small accumulator with a volume of less than 30 cm³, in particular with a volume of less than 10 cm³, and in particular with a volume of less than 1 cm³. Small batteries or small accumulators can be button cells. Button cells can have a round shape, whereby their diameter is preferably greater than their height. Alternatively, a small battery or a small accumulator can also be cuboidal or have any device-specific shape, such as a horseshoe shape or a drop shape. A device-specific shape is a shape that corresponds to the space available for a battery in the device or which makes better use of available space in the device in which the battery is to be used.

Small batteries or small accumulators can have a height of 6 mm or less, in particular 5 mm or less. Small batteries preferably have a single secondary cell, which in turn can include a large number of electrodes connected in parallel, whereby the batteries have a nominal voltage in the range from 1 V to 5 V, in particular from 1.3 V to 4 V, and in particular from 3 V to 3.8 V.

The electrode stack comprises a layered arrangement of electrodes. Each electrode includes active material or is coated with active material. The electrodes are preferably in the form of sheets of conductive material to which the active material is applied to or which are coated with the active material. Anode material is attached to the negative electrodes and cathode material is attached to the positive electrodes. The electrodes may be coated with active material on one or both sides. In an electrode stack, a negative electrode is followed by a positive electrode. A separator is arranged between the electrodes as a separating layer. A stack of electrodes may comprise a large number of electrodes. The layers of one type of electrode may preferably be welded between two layers of the separator.

The electrode stack preferably has a polyhedral shape. However, the electrode stack may also be in the shape of a cylinder or in any other shape, for example a horseshoe. The shape and size of the electrode stack is adapted to the shape and size of the cavity respectively of the housing.

An electrolyte solution is preferably filled into the electrode stack and/or into the cavity of the housing. A solution suitable for the type of battery is used as the electrolyte solution. If the battery is a lithium-ion battery or accumulator, a non-aqueous electrolyte solution, e.g. a salt solution or a polymer solution, is preferably used.

The at least one feed-through element is arranged in an opening of the housing, wherein the at least one feed-through element is connected to the housing in a sealing manner or wherein a seal is arranged between the at least one feed-through element and the housing. The feed-through element can be used to conduct electrical current from the cavity through the housing to the outside. The at least one feed-through element can thus serve as a contact outside the housing, with which the battery can be conductively connected to a consumer load.

The at least one feed-through element is preferably in the form of a cylindrical rod made of a conductive material, in particular a metal.

The fact that the at least one feed-through element protrudes at least partially into the cavity means that it can be easily connected to the contact element arranged inside the cavity. The connection between the at least one feed-through element and the at least one contact element is electrically conductive, for example by bringing the at least one feed-through element into physical contact with the contact element. The at least one feed-through element and the at least one contact element are preferably detachably connected to one another, in particular by means of a form fit or a force fit. A connection by means of a thread or a screw, for example, can be used as a detachable connection. Alternatively, however, the at least one contact element and the at least one feed-through element can also be firmly connected to each other, for example by an adhesive bond, such as soldering, welding or gluing.

The at least one feed-through element preferably interacts with the housing in such a way that a force is transmitted to the at least one contact element by the at least one feed-through element, which force is directed against the inner wall of the housing, so that a clamping force is exerted on the tab elements arranged between the at least one first surface of the contact element and the inner wall. As a result, the tab elements can be held clamped between the at least one first surface and the inner wall.

The tab elements may be configured as a conductive lattice, conductive carrier tape and/or conductive foil, each tab element being connected to an electrode and being free of active material.

The at least one contact element has a shape suitable for clamping the tab elements, with the at least one surface in particular having a shape complementary to the area of the inner wall onto which the tab elements are to be clamped. The at least one contact element is preferably a solid, in particular a polyhedron. Alternatively, however, the at least one contact element may also be shaped as a sphere, ellipsoid or ovoid.

The at least one contact element is preferably a solid body. Alternatively, however, the at least one contact element may also be designed as a hollow body.

By using the contact element to clamp the tab elements of the electrodes of the electrode stack with the same polarity against the inner wall, electrical current can flow from the tab elements into the contact element and vice versa, and the tab elements are securely and reliably fixed in place.

The tab elements of electrodes with the same polarity are preferably arranged in a stack, whereby the stack of tab elements is held clamped between the contact element and the inner wall. Alternatively, however, the tab elements of the electrodes with the same polarity may also be arranged side by side between the contact element and the inner wall.

Preferably, the battery comprises two feed-through elements and two contact elements, the tab elements of positive electrodes of the electrode stack being held in a clamping manner between at least the first surface of a first of the two contact elements and the inner wall, and the tab elements of negative electrodes of the electrode stack being held in a clamping manner between at least the first surface of a second of the two contact elements and the inner wall.

The two feed-through elements interact with the housing in such a way that a clamping force is exerted on the tab elements arranged between the first surfaces of the two contact elements and the inner wall.

The two contact elements are preferably spaced apart or separated from each other by a wall made of non-conductive material so that no short circuit occurs. Preferably, the tab elements of the positive electrodes and those of the negative electrodes are also spaced apart or separated by at least one non-conductive element in order to prevent short circuits.

The at least one feed-through element is preferably at least partially accommodated in a bore of the at least one contact element. The bore has essentially the same shape and dimensions as the at least one feed-through element. This ensures a secure connection between the at least one contact element and the at least one feed-through element.

The hole is preferably located on the first surface of the contact element, wherein the tab elements are pierced by the at least one feed-through element.

This additionally enables a direct, conductive contact between the tab elements and the feed-through element. Further, in addition to the frictional connection by clamping, the tab elements are thereby also fixed between the at least one contact element and the inner wall by means of a form fit connection.

The feed-through element is preferably designed as a screw. In this case, the bore preferably has an internal thread that is complementary to the thread of the feed-through element designed as a screw. Alternatively, however, the feed-through element designed as a screw may comprise a self-tapping thread that cuts into the contact element when screwed into the bore.

In addition to reliably fixing the feed-through element in the contact element, screwing can also generate the clamping force required to clamp the tab elements between the contact element and the inner wall or increase an existing clamping force.

In order to prevent the contact element from twisting when screwing in a feed-through element designed as a screw, which could sometimes lead to cracks in the tab elements, it must be secured against twisting, for example by means of appropriate brackets on the inner wall of the housing or by arranging a mounting aid.

Preferably, the at least one feed-through element has a self-cutting tip. This allows the at least one feed-through element to drill or cut itself through the tab elements during manufacture of the battery. As a result, no tab elements with a feed-through opening need to be used and it is also not necessary to align the feed-through openings of the tab elements with one another, for example when stacking the tab elements. This can significantly simplify the production of the battery.

Alternatively, however, the at least one feed-through element can also have a non-cutting tip, in particular a flat tip. In this case, the tab elements are provided in advance with a feed-through opening through which the at least one feed-through element can be passed.

Preferably, the at least one contact element and the at least one feed-through element are designed as a single-piece unit. This means that these two elements are present as a single component. This reduces the number of parts required to assemble the battery and reduces the assembly steps required to manufacture the battery.

The contact element is preferably designed as a cuboid. Preferably, the tab elements are further clamped between at least one other surface of the contact element and the inner wall. On the one hand, this increases the contact surface between the contact element and the tab elements and, on the other hand, increases the force with which the tab elements are held clamped between the contact element and the inner wall.

Preferably, the tab elements are also clamped between two other surfaces of the contact element and the inner wall. The two additional surfaces are preferably arranged parallel to each other. This means that the two additional surfaces of the cuboidal contact element are opposite each other. The contact element is preferably shaped and dimensioned in such a way that it may be placed inside the cavity such that there is just enough space between the two other surfaces and the inner wall of the cavity to insert all the tab elements of the electrodes with the same polarity between the contact element and the inner wall.

Preferably, the tab elements comprise at least one bend each between the electrode stack and the at least one contact element for strain relief. This largely prevents damage to the tab elements in the event of a relative movement between the contact element and the electrode stack.

Preferably, the tab elements comprise a loop between the electrode stack and the contact element. By provision of a loop, a particularly good strain relief can be achieved.

The at least one contact element is preferably made of a metal, in particular aluminum, nickel or copper. Metals can be easily formed into a contact element with a specific shape, e.g. by die casting, milling or sintering. In addition, a metal contact element is dimensionally stable, has a high tensile strength and good electrical conductivity.

Alternatively, however, the at least one contact element can also consist of an electrically conductive polymer.

The present invention further relates to a method of manufacturing a battery, in particular a battery according to the description above. In a first step of the method, a stack of electrodes is arranged on an assembly aid. Subsequently, tab elements of like-pole electrodes of the electrode stack are arranged between an inner wall of an open housing made of plastic or a cover element made of plastic and at least a first surface of at least one contact element made of a conductive material. The tab elements are preferably stacked one on each other. The at least one feed-through element is attached to the housing or cover element. The attachment is carried out in such a way that the at least one contact element connected to the at least one feed-through element exerts a clamping force on the tab elements attached between the at least one first surface and the inner wall. The assembly aid is then removed and the battery is assembled.

In the method for manufacturing a battery according to the invention, the housing of the battery can basically be present in two variants: In a first variant, the housing has an opening which can be closed by means of the cover element. In a second variant, the housing has two parts which are joined together when the battery is assembled.

In particular, the mounting aid has means with which the electrode stack can be precisely positioned relative to the cover element or within the open housing.

Preferably, the tab elements of the two electrode types, i.e. of the cathode and anode electrodes, are each arranged between the inner wall of the housing or the cover element and a distinct contact element. Furthermore, both contact elements are each connected to a distinct feed-through element.

In the first variant of the housing, the assembly of the battery includes inserting the electrode stack into the cavity of the housing, filling the cavity and/or the electrode stack with an electrolyte solution and closing the opening with the cover element and, preferably depending on the type of battery, further assembly steps. In the second variant of the housing, the assembly of the battery comprises filling the cavity and/or the electrode stack with an electrolyte solution, closing the housing and, preferably depending on the type of battery, further assembly steps.

Additionally, the mounting aid used in the method is preferably in the form of a wedge which has a nose at its pointed end, the mounting aid being placed on an inner wall of the open housing before step a) in such a way that the nose is directed away from the inner wall. Between the steps of arranging the tab elements and attaching the contact element, the tab elements are placed over this nose so that a bend is created between the electrode stack and the contact element for strain relief in the tab elements. This step is used in particular when using the second variant of the housing.

Preferably, between the arrangement of the electrode stack on the mounting aid and the arrangement of the tab elements, the at least one contact element is arranged in a defined position relative to the electrode stack on the mounting aid, with the tab elements then being placed on the contact element and finally the cover element being arranged on the tab elements. These steps are used in particular when using the first variant of the housing.

After removing the assembly aid, the at least one contact element is preferably rotated relative to the electrode stack, in particular by 90°, so that the at least one contact element points in the direction of the electrode stack, whereby during the step of assembling the battery, the electrode stack is first inserted through an opening into a housing and then the opening is closed by the cover element.

A feed-through element in the form of a screw is preferably used to fasten the at least one contact element in the housing or on the cover element, which is passed through an opening in the housing or the cover element and at least partially inserted into a bore in the contact element. The at least one contact element exerts the clamping force on the tab elements arranged between the at least one first surface and the inner wall by engagement of a thread of the feed-through element in the form of a screw in an internal thread of the bore and the interaction of a head of the screw with the housing or the cover element. The head of the screw can also be used as a contact surface, which can be used to electrically connect the battery to a load.

Preferably, the screw has a self-cutting tip with which the stacked tab elements are pierced or cut through. By piercing or cutting through the tab elements, which are preferably stacked one on each other, the tab elements can be mechanically secured against slipping in addition to being clamped.

Alternatively, the at least one feed-through element and the at least one contact element are preferably designed as a single-piece unit. The clamping force on the tab elements between the at least one first surface and the inner wall is exerted by deformation of an exposed end of the feed-through element, which is in the form of a pin and protrudes from the housing or from the cover element. The deformation takes place in particular by wobbling.

### BRIEF DESCRIPTION OF THE DRAWINGS

The drawings used to illustrate the embodiments show:

FIG. 1 a schematic side view of a first embodiment of a battery according to the invention;

FIG. 2 a detail from the manufacturing process for the embodiment of the battery according to the invention as shown in FIG. 1 as a schematic sectional view;

FIG. 3 a second embodiment of a battery according to the invention in a schematic side view;

FIG. 4 a detail of the manufacturing process for the embodiment of the battery according to the invention as shown in FIG. 3 as a schematic sectional view;

FIGS. 5 and 6 a third embodiment of a battery according to the invention, in which the contact element and the feed-through element are designed as a single-piece unit.

In principle, identical parts are marked with identical reference signs in the figures.

### WAYS TO CARRY OUT THE INVENTION

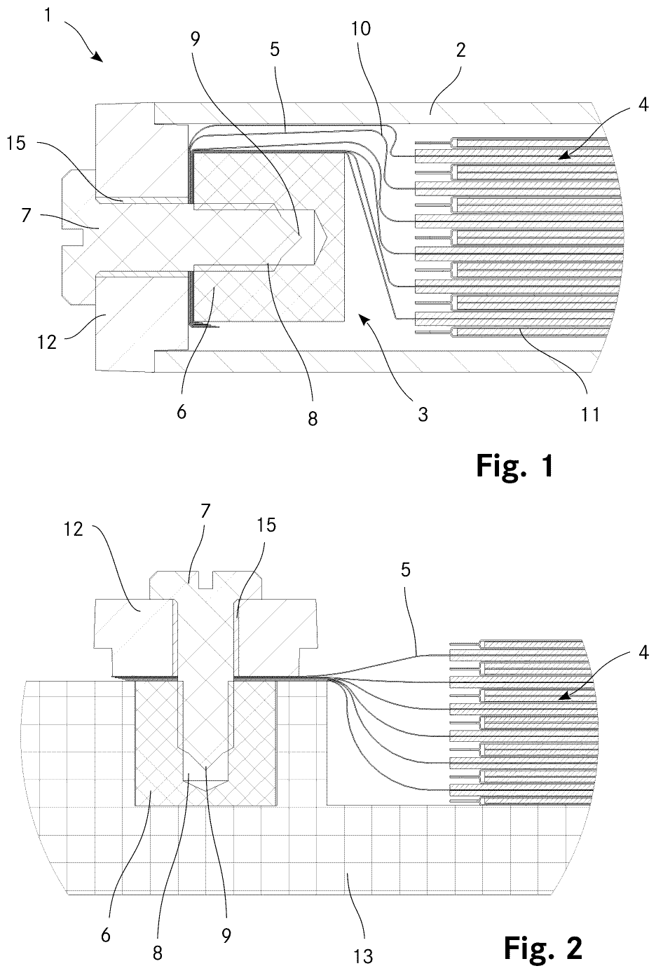

FIG. 1 shows a schematic side view of a first embodiment of a battery 1 according to the invention. The battery 1 has a housing 2 made of plastic, which comprises a cavity 3 delimited by an inner wall of the housing 2. The housing 2 has an opening which is closed by a cover element 12. An electrode stack 4 consisting of cathode and anode electrodes is arranged in the cavity 3. The cathode and anode electrodes are separated from each other by separators made of a non-conductive material. The cathode and anode electrodes each have a tab element 5, which is conductively connected to a feed-through element 7. The tab elements 5 of the anode electrodes and the tab elements 5 of the cathode electrodes are each connected separately to a distinct feed-through element 7. The sectional view in FIG. 1 shows only one feed-through element 7, which is electrically connected to the tab elements 5 of the cathode electrodes. In the embodiment shown, the feed-through element 7 is arranged in the cover element 12, which is also made of plastic. The electrode stack 4 is filled with an electrolyte solution 11.

To fix the tab elements 5 in place, the tab elements 5 are clamped in layers between two surfaces of a contact element 6 made of a conductive material and an inner wall of the cover element 12 and an inner wall of the housing 2. In the embodiment shown, the solid body 6 has a cubic shape. The feed-through element 7, designed as a screw, is accommodated in a bore 8 of the contact element 6, with an internal thread complementary to the thread of the screw being present within the bore 8. The feed-through element 7 extends through an opening in the cover element 12 and penetrate through the tab elements 5, which are stacked on top of each other, thus additionally fixing the tab elements 5 and placing them in direct electrically conductive contact with each other. The feed-through element 7, which is designed as a screw, has a tip 9, in particular a self-cutting tip, with which the feed-through element 7 can pierce or cut through the stacked tab elements 5 during the manufacture of the battery 1. By screwing in the feed-through element 7, which is designed as a screw, the necessary force can be generated to securely fasten the stacked tab elements 5 between the contact element 6 and the inner wall of the cover element 12. Since the contact element 6 is made of a conductive material and has a large contact surface to the stacked tab elements 5, safe current transfer from the tab elements 5 to the contact element 6 is guaranteed. There is also a large contact surface between the feed-through element 7, which is designed as a screw, and the contact element 6, so that safe current transmission also takes place here. Overall, the battery 1 according to the invention ensures simple and secure attachment of the tab elements 5, while at the same time ensuring reliable current transmission from the tab elements 5 to the feed-through element 7 (via the contact element 6, among others). By means of the feed-through element 7, an electrically conductive connection can be established between the battery 1 and an external consumer, e.g. a medical device.

The tab elements 5 each have a bend 10 as strain relief. This bend 10 can prevent individual tab elements 5 from tearing when the electrode stack 4 moves relative to the contact element 6.

A seal 15 is arranged between the feed-through element 7 and the cover element 12 to prevent the electrolyte solution from flowing out of the cavity.

FIG. 2 shows a detail from the manufacturing process for the embodiment of the battery 1 according to the invention as shown in FIG. 1 as a schematic sectional view. In the manufacturing process shown, the electrode stack 4 and the contact element 6 are first placed on an assembly aid 13. The assembly aid 13 facilitates the exact positioning of the contact element 6 and the electrode stack 4 relative to each other. The tab elements 5 of the cathode or anode electrodes are then stacked on top of each other and placed accordingly on a first surface of the contact element 6. The cover element 12 is then placed on the contact element 6 and a feed-through element 7 in the form of a screw is pushed through the opening of the cover element 12. By means of the tip 9, which is designed in particular as a self-cutting tip, the stacked tab elements 5 can be pierced or cut through by the feed-through element 7. The feed-through element 7 is screwed into the corresponding hole 8 of the contact element 6. After fixing the tab elements 5 between the cover element 12 and the contact element 6, the electrode stack 4 is pushed into the cavity 3 of the housing 2, preferably through an opening in the housing 2, and the cover element 12 is pivoted through 90° together with the solid body, the cover element 12 then being inserted into the opening in the housing to close it. This swivel movement and the insertion of the cover element 12 into the opening of the housing create the bend in the tab elements 5 that serves as strain relief. Before closing the housing 2, the electrode stack 4 is preferably filled with the electrolyte solution 11.

It is understood that not only the tab elements 5 of one type of electrode, i.e. the anode electrodes or the cathode electrodes, can be connected to a feed-through element 7 in this way, but also the tab elements 5 of both types of electrodes. In such a case, two contact elements 6 and two feed-through elements 7 are each used in the manufacturing process in the manner described above.

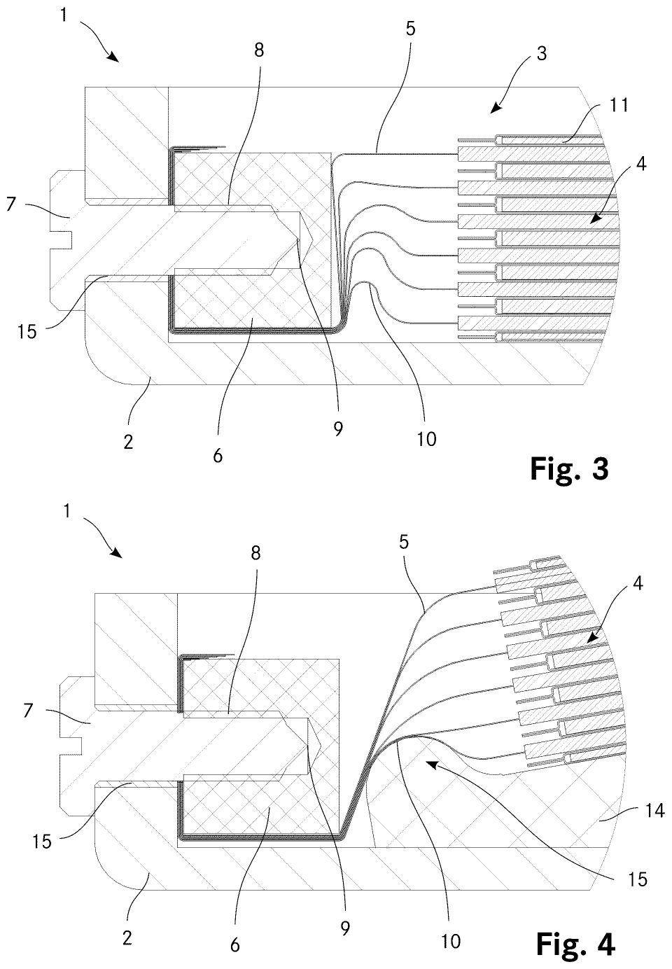

FIG. 3 shows a second embodiment of a battery 1 according to the invention in a schematic side view. In contrast to the embodiment shown in FIG. 1, the feed-through element 7 protrudes through an opening in the housing 2. The tab elements 5 of the anode and cathode electrodes are stacked in a similar manner and are held clamped between the inner wall of the housing and a contact element 6. Between the electrode stack 4 and the contact element 6, the tab elements 5 each have a bend 10, which is loop-shaped in the embodiment shown.

FIG. 4 shows a detail from the manufacturing process for the embodiment of the battery 1 according to the invention as shown in FIG. 3 as a schematic sectional view. The housing 2 has a removable cover or consists of two parts which are joined together so that it is possible to work with the housing open or with the parts not joined together during manufacture. During the manufacturing process, a wedge 14 is first placed on the inner wall of the housing in a defined position. The wedge 14 has a rounded nose 15 at its pointed end, which points away from the inner wall of the housing 2 when the wedge 14 is placed on the inner wall of the housing 2. The electrode stack 4 is then placed on the wedge 14 and the tab elements 5 of the anode and cathode electrodes are stacked on top of each other. The stacked tab elements 5 are placed over the nose 15 of the wedge 14 and bent around the contact element 6. The contact element 6 is attached to the housing 2 by means of a feed-through element 7 designed as a screw, which is pushed through an opening in the housing 2, and pressed against the inner wall of the housing 2 so that the stacked tab elements 5 are held clamped between the contact element 6 and the inner wall of the housing 2. The feed-through element 7 again has a tip 9, in particular a self-cutting tip, so that the stacked tab elements 5 can be pierced or cut through by the feed-through element 7 before the feed-through element 7 is screwed into the contact element 6. The wedge 14 is then removed and the electrode stack 4 is placed in its place on the inner wall of the housing 2. The preformed bend 10 of the tab elements 5, which serves as strain relief, remains in place due to the contact with the nose 15. The wedge 14 and the nose 15 prevent the tab elements 5 from bending in the wrong direction or even kinking. Finally, the electrode stack 4 is filled with an electrolyte 11 and the housing 2 of the battery 1 is closed or assembled.

It is understood that not only the tab elements 5 of one type of electrode, i.e. the anode electrodes or the cathode electrodes, can be connected to a feed-through element 7 in this way, but also the tab elements 5 of both types of electrodes. In such a case, two contact elements 6 and two feed-through elements 7 are each used in the manufacturing process in the manner described above.

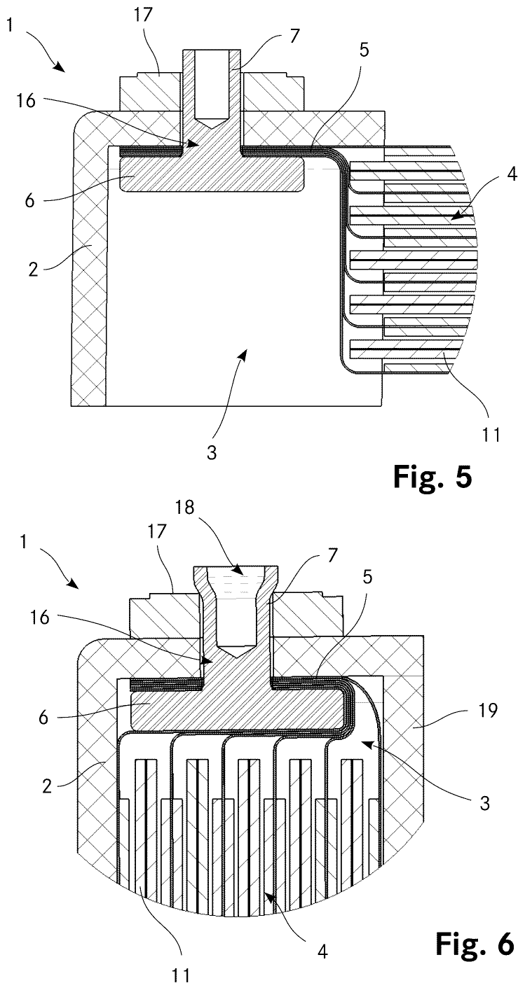

FIGS. 5 and 6 show a third embodiment of a battery 1 according to the invention. In this embodiment, the contact element 6 and the feed-through element 7 are formed as a single-piece unit 16. The contact element 6 is in the form of a plate or disk, from the center of which the feed-through element 7 extends in the form of a cylindrical pin. The feed-through element 7 protrudes from the housing 2. In the area of the housing 2 from which the feed-through element 7 protrudes, a reinforcing plate 17 is arranged, through which the feed-through element 7 is passed. In the area of a first end 18, the feed-through element 7 is present as a hollow body.

The free end 18 of the feed-through element 7 is then deformed in order to exert a clamping force on the tab elements 5 arranged between the first surface of the contact element 6 and the inner wall of the housing 2. The free end 18 is preferably deformed by wobbling.

When installing the battery 1, the electrode stack 4 is positioned outside the housing 2 and is then swivelled through 90° and inserted into the cavity 3. The tab elements 5 are then bent around the contact element 6. The housing 2 is then closed with a cover 19, as shown in FIG. 6.

We claim:

1-16. (canceled)

17. A battery comprising:
a housing made of plastic, which comprises a cavity defined by an inner wall of the housing;
a stack of electrodes arranged in the cavity;
at least one feed-through element which extends from a surface of the housing through the housing at least partially into the cavity;
wherein at least one contact element made of a conductive material is arranged within the cavity and is connected to the at least one feed-through element;
tab elements of electrodes of the same polarity of the stack of electrodes are arranged between at least one first surface of the at least one contact element and the inner wall, and
wherein the feed-through element interacts with the housing in such a way that the at least one contact element exerts a clamping force on the tab elements arranged between the at least one first surface and the inner wall.

18. The battery according to claim 17, wherein the at least one feed-through element is at least partially accommodated in a bore of the at least one contact element.

19. The battery according to claim 18, wherein the bore is arranged on the first surface of the at least one contact element, and wherein the tab elements are pierced by the at least one feed-through element.

20. The battery according to claim 18, wherein the at least one feed-through element is configured as a screw.

21. The battery according to claim 19, wherein the at least one feed-through element has a self-cutting tip.

22. The battery according to claim 17, wherein the at least one feed-through element and the at least one contact element are designed as a single-piece unit.

23. The battery according to claim 17, wherein the at least one contact element is designed as a cuboid, the tab elements additionally being held in a clamping manner between at least one further surface of the at least one contact element and the inner wall.

24. The battery according to claim 17, wherein the tab elements comprise at least one bend between the electrode stack and the at least one contact element for strain relief.

25. The battery according to claim 17, wherein the battery includes two feed-through elements and two contact elements, the tab elements of positive electrodes of the electrode stack being held in a clamping manner between at least the first surface of a first contact element of the two contact elements and the inner wall and the tab elements of negative electrodes of the electrode stack being held in a clamping manner between at least the first surface of a second contact element of the two contact elements and the inner wall.

26. A method of manufacturing a battery, comprising
a housing made of plastic, which comprises a cavity defined by an inner wall of the housing;
a stack of electrodes arranged in the cavity;
at least one feed-through element which extends from a surface of the housing through the housing at least partially into the cavity;
wherein at least one contact element made of a conductive material is arranged within the cavity and is connected to the at least one feed-through element;
tab elements of electrodes of the same polarity of the stack of electrodes are arranged between at least one first surface of the at least one contact element and the inner wall, and
wherein the feed-through element interacts with the housing in such a way that the at least one contact element exerts a clamping force on the tab elements arranged between the at least one first surface and the inner wall,
the method comprising the steps of:
a) arranging of the electrode stack on a mounting aid;
b) arranging of the tab elements of like-pole electrodes of the electrode stack between the inner wall of the open housing made of plastic or a cover element made of plastic and at least the first surface of the at least one contact element;
c) fastening the at least one feed-through element to the housing or to the cover element, the at least one feed-through element interacting with the housing or cover element in such a way that the contact element connected to the at least one feed-through element exerts a clamping force on the tab elements arranged between the at least one first surface and the inner wall;
d) removing the mounting aid; and
e) assembling the battery.

27. The method according to claim 26, wherein the mounting aid is in the form of a wedge which has a nose at its pointed end, the mounting aid being placed on an inner wall of the open housing before step a) in such a way that the nose is directed away from the inner wall, and the tab elements being placed over this nose between steps b) and c), so that a bend for strain relief is thereby produced in the tab elements between the electrode stack and the at least one contact element.

28. The method according to claim 26, wherein, between steps a) and b), the at least one contact element is arranged in a defined position relative to the electrode stack on the mounting aid, the tab elements being placed on the at least one contact element in step b) and the cover element then being arranged on the tab elements.

29. The method according to claim 28, wherein after step d) the at least one contact element is rotated relative to the electrode stack so that the at least one contact element points in the direction of the electrode stack, wherein in step e) the electrode stack is first pushed through an opening into a housing and then the opening is closed by the cover element.

30. The method according to claim 26, wherein in step c) at least one feed-through element in the form of a screw is used, which is passed through an opening of the housing or of the cover element and is at least partially inserted into a bore of the at least one contact element, wherein the at least one contact element exerts the clamping force between the at least one surface and the inner wall on the tab elements by engagement of a thread of the at least one feed-through element in the form of a screw in an internal thread of the bore and the interaction of a head of the screw with the housing or the cover element.

31. The method according to claim 30, wherein the screw has a self-cutting tip, with which the tab elements stacked on top of one another are pierced.

32. The method according to claim 26, wherein the at least one feed-through element and the at least one contact element are designed as a single-piece unit, the clamping force being exerted on the tab elements between the at least one first surface and the inner wall by deformation of an exposed end of the feed-through element, which projects from the housing or from the cover element and is in the form of a pin.

33. The method according to claim 32, wherein the exposed end of the feed through element is deformed by wobbling.
